(19) United States
(12) Patent Application Publication
(10) Pub. No.: US 2013/0066690 A1
(43) Pub. Date: Mar. 14, 2013

(54) CAR PARK CONTROL SYSTEM USING A THIRD-PARTY SYSTEM

(71) Applicant: Arturo Echanove Hernandez, Del. Azcapotzalco (MX)

(72) Inventor: Arturo Echanove Hernandez, Del. Azcapotzalco (MX)

(21) Appl. No.: 13/697,695

(22) PCT Filed: May 13, 2011
(86) PCT No.: PCT/MX11/00056

§ 371 Date: Nov. 14, 2012

(30) Foreign Application Priority Data
May 14, 2010 (MX) MX/A/2010/005386

(51) Int. Cl. G06Q 50/30; G06Q 10/02

(52) U.S. Cl. 705/13

(57) ABSTRACT

A parking lot control system using a third-party system, having at least one transmitting device emitting an entry ticket including first and second sets of reading data, the first set of data being read by the third-party system which emits an exit password upon fulfillment of parking lot exit conditions. The control system also includes: a processing unit which communicates with the third-party system in order to receive the exit password therefrom, and at least one exit validation device which receives the exit password from the processing unit and reads the first and/or second set of data on the entry ticket in order to allow the release of vehicles having a ticket corresponding to the exit password generated by the third-party system. If no exit password is received, the validation device can operate redundantly in order to allow the release of vehicles meeting the exit conditions.

### FIELD OF THE INVENTION

The present invention is related to the techniques used in the manufacture and design of control systems, communications and data flow for the entrance and exit of vehicles in parking lots, and more particularly, it is linked to a control system through a third-party system, the control system allows safe and reliable exit of vehicles even where a failure is presented in the communication of the control system with the third-party system.

### BACKGROUND OF THE INVENTION

It is widely known that the establishments where people arrives on its vehicle, such as malls, stadiums, hotels, supermarkets, schools, amusement centers, etc., they all have parking lots, where it is necessary to have a system that has control of every vehicle that enters and dwell time thereof in order to allow the exit of only those vehicles that meet the conditions to leave the parking lot.

Broadly, in a parking lot, a ticket is delivered to the user upon entering, who must meet certain conditions to get out. Also, the establishment where the parking lot is present, seals, marks, exchanges, drills or encodes the entry ticket of vehicle to provide the user a preferential use of its establishment rate by doing an activity within its facilities. Many times, this preferential rate is valid for a given period of time, depending on each parking lot.

However, there are computers or automated systems where an entry ticket is issued, for example, a ticket which indicates the time and date of vehicle entry to the parking lot, then this entry ticket is read on a prepaid device or at the exit of the parking lot, where if the user complies with the conditions laid down, it generates an exit password through which a validator unlock the exit of the parking lot by lifting the pen, bar or gate that obstructs the exit.

However, this automated system has some disadvantages since if the exit password is not issued for any reason, a chaos is generated in the exit of the parking lot, since the system does not allow the output of vehicles, which flock to the output; and in this case, what is being done to resolve this situation is to manually allow the output of vehicles without verifying that the fee has been paid and giving to a vehicle the chance of exiting the parking lot without meeting the releasing requirements. I.e., these systems are bound to the issuance of the exit password from the own parking system or from the third-party system in order to be able to continuously operate.

In addition, pre-payment machines need maintenance and sometimes their number is not enough to assist all the users, creating rows and unnecessarily delaying the departure of the vehicle.

In this way, in places such as malls or other facilities, it has been considered to take advantage of sales point terminals, such as cash registers, customer service kiosks, etc., to verify the conditions in order to allow the output and speed up the flow of vehicles, making this necessary that the terminals are connected to the third-party system which issue the exit password. However, there is the permanent risk that if for some reason there is a local or widespread failure in the establishment system, and the exit password is not send to the exit validation, problems such as those already mentioned are generated, i.e. that the payment cannot be done by the output and a chaos is generated.

Therefore, you can see that there is a need for new systems of parking lots control, which allow a reliable control over it and allow to confront eventualities such as the absence, loss or delay of exit password or to carry out the collection independently to the establishment system.

### BRIEF DESCRIPTION OF THE INVENTION

In accordance with the above, we have sought to eliminate the disadvantages of traditional systems, developing a parking control system through a third-party system a, the present system comprises at least one transmitting device of entry ticket to the parking lot, where the ticket includes a first group of reading data and a second group of reading data, where the first group of data is read by the third-party system which issues an exit password to meet the releasing conditions of the parking lot.

Preferably, the first group of data has a first reading code which belongs to a third-party system and the second group of data has a second reading code different to the first reading code.

The exit password can include at least a ticket's identification number or at least the ticket's identification number and a maximum output time.

A characteristic part of the system of the present invention is a processing unit in communication with the third-party system to receive from this latest the exit password; and another element of the system is at least one exit validation device in communication with the processing unit; the exit validation device receives the exit password from the processing unit to only allow the release of those vehicles whose ticket has an exit password assigned, if being the case not having the exit password, the exit validation device prevents the release of the vehicle until the output conditions are met.

More particularly, the validator output device reads the first and/or the second group of data and links the data of the proof of the first or second group with exit password generated by the third-party system to allow the exit from the parking lot. I.e., the exit validation device ensures that the exit ticket corresponds to the password that has been generated by the third-party system. To do this, the validator comprises a memory to store the passwords generated by the third-party system and it links them to the respective ticket by the time the user drives the validator device in order to exit the parking lot.

In case that the validator device does not have the exit password, i.e., that for some reason the third-party system have not generated, transmitted, stored it, etc., the validator device prevents the vehicle release until the user complies with the conditions to leave the parking lot.

From another point of view, the system of the present invention achieves a redundant control over ticket allowing you to reliably operate the parking lot in normal situations and, above all, in emergency situations jointly or separately from the third-party system.

In an embodiment of the invention, the entry ticket is a printed ticket, a ticket with magnetic strip, a card or some other device or medium with memory. In another embodiment, the third-party system is in communication with one or more parking lots.

In another embodiment, the exit validation device has a memory to store the exit password of each ticket that has complied with exit conditions of the parking lot.

To give security to the third-party system, the new system processing unit communication with the third-party system is protected against strangers, communication can be both wired or wireless under various protocols, a wired communication through an interface RS 232 type being preferred.

From the above, it can be mentioned that it is an object of the present invention to provide a parking lots control system, where the system has the ability to allow parking users release by presenting the ticket and validating the conditions compliance for exiting the third-party system or in the control system.

### BRIEF DESCRIPTION OF THE DRAWINGS

FIG. 1 is a diagram that shows a first embodiment of the control system of the present invention.

FIG. 2 is a schematic representation of an entry ticket that can be generated in the system of the present invention.

FIG. 3 is a diagram that shows a second embodiment of the control system of the present invention.

### DETAILED DESCRIPTION OF THE INVENTION

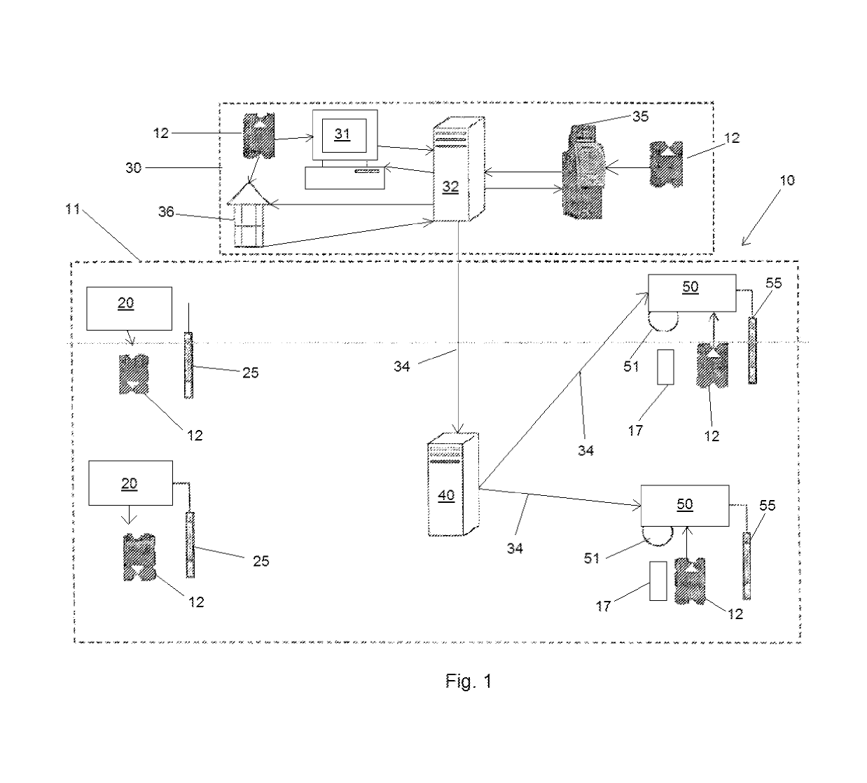

Referring to the attached drawings, and more specifically, to FIG. 1, it is shown a control system 10 of a parking lot 11 in communication with a third-party system 30 of any establishment, which in the present invention can be a mall, a stadium, a hotel, a restaurant, etc., i.e., those places where a parking lot control is needed by its own establishment system.

System 10 comprises at least one transmitting device 20 of an entry ticket 12 in the form of a ticket, the ticket can also be an electronic chip card, a ticket with magnetic strip, any device with memory, etc. In the described embodiment, the ticket includes a first group of reading data and a second group of reading data, where the first and the second group of reading data are unique for each ticket, date and issuing time thereof, the issuer identification that generated the ticket, etc. By taking the ticket 12, the entry bar 25 rises. It is desirable to indicate that, in some parking lots, there is a card reader that also allows access.

When you want to leave the parking lot 11, third-party system 30 reads the first group of reading data and emits an exit password 34 exclusive for each ticket 12 when releasing conditions of the parking lot 11 are met.

In the described embodiment, the third-party system 30 validates the conditions so that you can generate the exit password, for example, if the user has made any authorized activity in the establishment and lies within a maximum output time, which simplifies the information flow in the third-party system 30, whenever the third-party system reads the first group of data and takes some of the ticket's identification data to generate the exit password including the corresponding data. The password is sent to the control system 10, more precisely; it is sent to a processing unit 40 communicating with the third-party system 30.

In the described embodiment, third-party system 30 includes at least a verifier device to make the reading of the first group of data; the reading terminal can be a customer service kiosk 36, a sales point terminal 31, an ATM 35, or any other checker device that validates the release conditions of the parking lot through the ticket.

The processing unit 40 is in communication with the third-party system 30 and with at least one exit validation device 50 and other peripheral devices as an ATM. The exit validation receives the exit password 34 of the processing unit 40 and read the first and/or the second group of data of the ticket to link data from the first and/or second group of data with the corresponding password to only allow the release of those vehicles whose ticket has a password assigned in association with said ticket, lifting the output bar 55.

However, if it does not exist the exit password 34, in the described embodiment, the exit validation device 50 reads the first and/or second group of data and only allows the release of vehicles if the vehicle is within the maximum output time and in case of exceeding the maximum output time, the validator device 50 prevents the output until the exit conditions are met.

As can be seen, the processing unit 40 and the validator device 50 can act if the third-party system 30 presents some kind of fault, solving any contingency.

Speaking a little more about each of the system components 10, it can be mentioned that the transmitting device 20 can be one of the well known in the art, such as those in which a button is pressed and a ticket or other proof is issued, or those which automatically detect the presence of the vehicle and the entry bar 25 raises by taking it, however, the transmitting device of the present invention is not restricted to these mentioned devices, but also the transmitting device can be a remote system that send a ticket to the email account or to the cell phone of an user that prints on its own the ticket and that it can be read or identified upon entering the parking lot.

A point that should be noted, is that what is important for the present invention is that the transmitting device issues the ticket with a first group of data and a second group of data, preferably, the first group of data is under an encoding that is only read and translated by the third-party system, while the second group of data is found under another encoding that is read by the exit validation device.

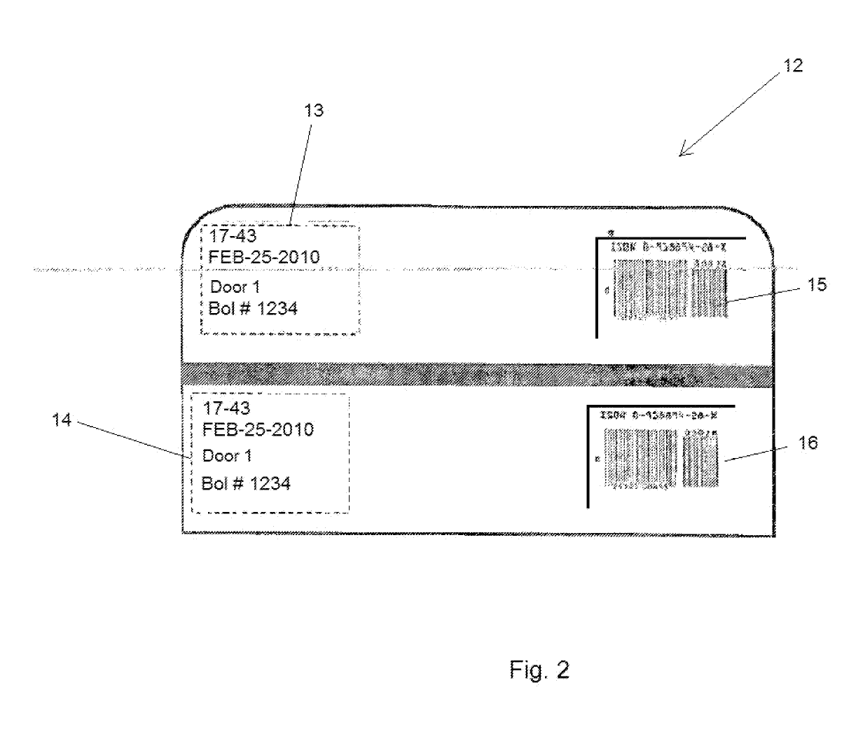

To explain this feature, FIG. 2 is referred where an entry ticket is present in the form of a ticket that includes the first group of data 13 and the second group of data 14, data may be associated with the date and time of entry, voucher number, or the transmitting device identification which generates the ticket or another useful information. Each group of data 13 and 14 is associated with a first and second reading code and 16, respectively, in order to process the ticket in the third-party system or the exit validation device.

For the safety of the ticket, especially in vehicle output, the second group of data can be encrypted, i.e., that only through appropriate means of decryption or reading on the validator device, you can read and know the ticket details. In addition, the ticket 12 may include a third group of data so that each ticket is unalterable, such as a list of special characters or other non-falsifiable printing.

Back to FIG. 1, once the user wants to leave the parking lot, this is informed to the third-party system 30, which can control one or more parking lots, but it is very important to mention that the third-party system 30 only processes the first group of data and has a system of management and validation of the conditions for the vehicle release.

In an establishment such as a mall or supermarket, the third-party system 30 may be comprised of at least one sales point terminal 31, kiosk 36 or cash register or any device where the user can perform validation of his departure to leave the parking lot. The sales point terminal 31 may include a ticket's reader for ticket reading, the third-party system can also include one or more centralized systems 32 connected to every validation device of the third-party system ticket. In the third-party system 30, it is checked if the ticket is within a maximum output time and once the conditions of output have been met it sends the signal to the centralized system 32 where it generates and assigns the exit password 34 and a time of grace is given to the user to leave the parking lot, for example, it is generally granted a grace period of 15 minutes.

In the described embodiment and to facilitate the information processing, the third-party system generates the exit password including the identification data of the ticket, which is sent to the processing unit 40, which facilitates the operation of the system 10 and the third-party system 30 making it steadier.

As usual, if the user makes any activity in the establishment he enjoys privileges for the use of the parking lot, usually for a time set by the establishment, hence the importance of taking advantage of the infrastructure of the third-party such as kiosks, POS, ATMs or any device for verification of conditions for vehicles to perform the necessary validation and thus speed out the output of vehicles, which represents an advantage for the user and for the same owner or manager of the parking lot.

In the event that the user has exceeded the maximum exit time, the validator device does not allow the departure of the vehicle until validating the exit conditions in one of the validator devices of the third-party system or in the validator devices 50 of control system. The validator device 50 can be a reception and automatic reading of tickets module or a collection box assisted by an operator or an entry tickets collecting device to the parking lot.

Release 34 password is sent to the processing 40 unit, which stores, concentrate, manages and distributes all exit codes received toward each and every exit validation device as well as other peripheral devices, such as ATMs connected to the processing unit.

The communication between the third-party system 30 and processing unit 40 can be wired or wireless, under different protocols, preferably, the third-party system 30 is wired connected to the processing unit 40 and preferably using the interface type RS 232.

The processing unit 40 can materialize in the form of a personal computer, a laptop computer, a server, or a circuit board that connects to the third-party system, being possible to use for it an RS 232 interface.

Now, since most of the establishments have restricted access to their networks, the third-party communication system 30 with the processing unit 40 may be protected, for example, through the use of “firewalls”, which is a part of a system or a network that is designed to block unauthorized access, but allows at the same time authorized communications. It is a device or set of devices configured to allow, restrict, encrypt, decrypt the traffic between the different areas on the basis of a set of rules and other criteria.

Each exit validation device 50 receives and stores data from all those released tickets 12, what is known as a “white list”, this avoids the user having to repeat unnecessary validation, and by default it stores data of those tickets which have not been released by exit password ‘blacklist’.

The validator device 50 plays a very important part in the system since it prevents the release if the time of permanence of the vehicle is more than a maximum departure time until complying with exit conditions.

Also in the event that the user has not taken advantage of the preferential terms to do any activity within the establishment, the validator device 50 can include a mean 51 to read information from a document 17 issued by the third-party that grants preferential conditions to leave the parking lot, a purchase ticket made in any authorized parking lot and produced by the third-party.

It is very convenient to indicate that the present invention generates a redundant control over the ticket to issue dealing with situations of emergency, and providing, at the same time, security to the third-party system since the control system is not necessarily linked with the exit password that generates the third-party system to allow the exit of the parking lot.

Additionally, the control system can store the information of those tickets that do not have an exit password in the validator but still actionable on his own for the release of the respective vehicle, in this way, after a day or a period of time, all that information from records stored by the system 10 who did not have an exit password can be integrated to that stored by the third-party system 30 in order to globally be aware of every entry and exit operation from the parking lot.

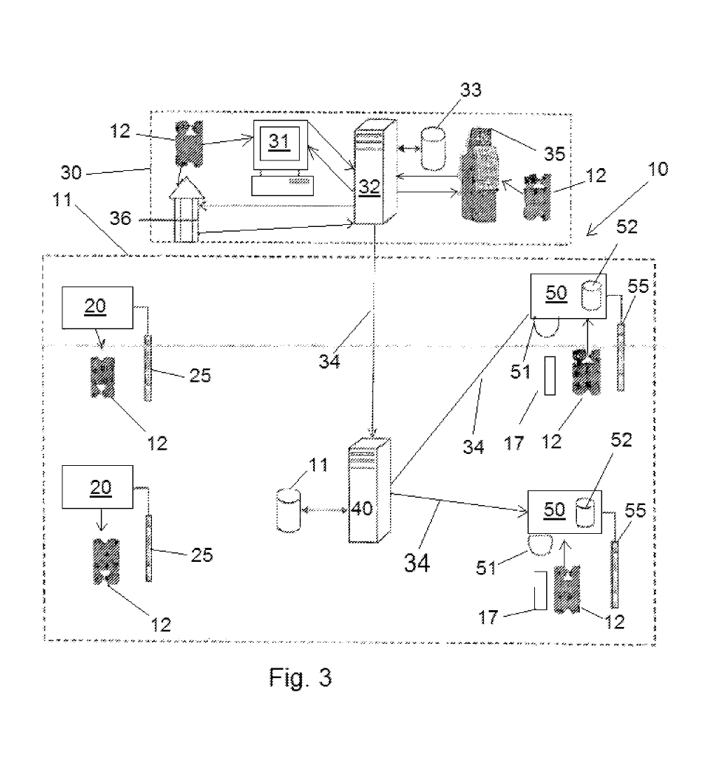

Now, referring to FIG. 3, where it is described a second embodiment of the system of the present invention, in this embodiment, the third-party system 30 validates tickets either they are within the maximum time or exceed it.

Under this embodiment, the third-party system 30 requires to process more information and have applications to perform the validation of exit conditions, the centralized system 32 includes a database 33 that stores information of each ticket 12 and generates an exit password 34 not only with the identification number of the ticket but also with details such as the maximum allowable output time, number of issuer, etc. Under these circumstances, the processing unit 40 also has a database 41 to handle this information, as well as the validators 50 include a database 52 for this purpose, validator devices 50 are connected at least to a central system to exchange, store and manage the flow of information, but the same goal is achieved for controlling the exit of the parking lot when an exit password 34 does not exist.

The processing unit 40 detects when there is any problem with the generation of exit passwords from the third-party system and sends the instruction to redundantly operate the parking lot in order to translate the second group of data and to only allow the release of those vehicles submitting a valid entry ticket to the parking lot.

The processing unit 40 has ability to send the exit passwords to the validation devices 50 such as ATMs and sales points of the parking system in order to avoid unnecessary verification of entry tickets to the parking lot that have already been processed in the third-party system. The other items identified with numeric references in FIG. 3 have been already described previously.

Although certain preferred embodiments of the present invention have been described and exemplified, it should be noted that there are various possible changes thereto, such as the ticket type, the way in which the first and second group of data are included in the equipment for the third-party system or the invention shall not be considered as restricted except by required from the previous technique and the scope of the attached claims.

### REFERENCES LIST

10 Control system
11 Parking lot
12 Entry ticket
13 First Group of Data
14 Second Group of Data
15 First Reading Code
16 Second Reading Code
17 Document from Third-Party System
20 Ticket Transmitting Device
25 Entry Bar
30 Third-Party System
31 Sales Point Terminal
32 Third-Party Centered System
33 Third-Party Centered System's Database
34 Exit Password
35 Pre-Pay Terminal
36 Kiosks
40 Processing Unit
41 Processing Unit's Database
50 Exit validation Device
51 Document Reader
52 Exit Validation Device's Database
55 Output Bar

1. A parking lot control system through a third-party system, comprising:
a) at least one parking lot entry ticket transmitting device, where the ticket includes a first group of reading data and a second group of reading data, where the first group of data is read by the third-party system which issues an exit password to meet exit conditions of the parking lot;
(b) a processing unit in communication with the third-party system to receive from the latest the exit password; and
(c) at least one exit validation device in communication with the processing unit; receiving the exit validation device the exit password of the processing unit and reading the first or second group of ticket data to allow the release of vehicles whose ticket has assigned an exit password or if it doesn't have the exit password, the validator device manages vehicle releasing until exit conditions are met.

2. The parking lot control system through a third-party system, in accordance with claim 1, wherein that the first or the second group of data includes at least one of the following data: entry time and date, ticket number and identification of the transmitting device who issued the ticket.

3. The parking lot control system through a third-party system, in accordance with claim 1, wherein that the first group of data has a first reading code and the second group of data has a second reading code different from the first reading code.

4. The parking lot control system through a third-party system, in accordance with claim 1, wherein that entry ticket is a ticket, a card or a ticket with magnetic strip.

5. The parking lot control system through a third-party system, in accordance with claim 1, wherein that the second group of data is encrypted on the ticket.

6. The parking lot control system through a third-party system, in accordance with claim 1, wherein that the exit password includes at least the ticket identification number.

7. The parking lot control system through a third-party system, in accordance with claim 1, wherein that the exit password includes at least the ticket number and a maximum output time.

8. The parking lot control system through a third-party system, in accordance with claim 1, wherein that the third-party system is in communication with one or more parking lots.

9. The parking lot control system through a third-party system, in accordance with claim 1, wherein that the third-party system includes an authentication device to make the reading of the first group of data.

10. The parking lot control system through a third-party system, in accordance with claim 1, wherein that the reading terminal is a customer service kiosk, a sales point terminal, an automated teller machine or any authentication device for exit conditions in the third-party parking lot.

11. The parking lot control system through a third-party system, in accordance with claim 1, wherein that the third-party management system communication with the processing unit is protected against strangers.

12. The parking lot control system through a third-party system, in accordance with claim 1, wherein that the third-party management system is wired or wireless connected with the processing unit.

13. The parking lot control system through a third-party system, in accordance with claim 1, wherein that the wired communication is done through an interface type RS 232.

14. The parking lot control system through a third-party system, in accordance with claim 1, wherein that the processing unit is a personal computer, a laptop computer, an electronic card or a computer program.

15. The parking lot control system through a third-party system, in accordance with claim 1, wherein that the processing unit receives stores, manages, and distributes the exit password for parking lot control system.

16. The parking lot control system through a third-party system, in accordance claim 1, wherein that the processing unit receives stores, manages and distributes the exit password to a peripheral device.

17. The parking lot control system through a third-party system, in accordance with claim 1, wherein that the exit validation device has a memory that stores each exit password of each ticket that has complied with the parking lot exit conditions.

18. The parking lot control system through a third-party system, in accordance with claim 1, wherein that if lacking for exit password, the exit validation device allows vehicles release only if the vehicle is within a maximum output time allowed.

19. The parking lot control system through a third-party system, in accordance with claim 1, wherein that the exit validation device is a ticket receiving and automatic reading module or a collection cahier assisted by an operator or a parking lot entry ticket collection device.

20. The parking lot control system through a third-party system, in accordance with claim 1, wherein that the exit validation device has means to read information from a document issued by the third-party which gives preferential terms to leave the parking lot.

21. The parking lot control system through a third-party system, in accordance with claim 20, wherein that the document is a purchase ticket made in any authorized establishment and generated by at least one third-party.

22. The parking lot control system through a third-party system, in accordance with claim 1, wherein that the processing unit detects when there is any problem with the generation of exit passwords of the third-party system and sends the instruction to redundantly operate the parking lot control system in order to translate the second group of data and only allow the release of vehicles showing a valid entry ticket to the parking lot.

23. The parking lot control system through a third-party system, in accordance with claim 1, wherein that the processing unit to send the exit passwords to the validation device prevents unnecessary verification of entry tickets to the parking lot that have already been processed in the third-party system.
